(19) United States
(12) Patent Application Publication
(10) Pub. No.: US 2006/0047653 A1
(43) Pub. Date: Mar. 2, 2006

(54) Systems and methods for navigating to multiple destination types through a single search interface in a development environment

(75) Inventors: Shankar Vaidyanathan, Sammamish, WA (US); Tarek Madkour, Sammamish, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/929,585

(22) Filed: Aug. 30, 2004

(51) Int. Cl. G06F 17/30

(52) U.S. Cl. 707/6

(57) ABSTRACT

Systems and methods are provided for navigating to multiple destination types from a single search interface element in an Integrated Development Environment (IDE) Graphical User Interface (GUI). Exemplary destination types are files, lines of code, symbols, bookmarks, and tool windows. An algorithm can be used to automatically determine a likely destination type from any characters entered into a search element. The automatically determined destination type can be prioritized in the search. The burden of specifying an appropriate type of search element is thus shifted away from the developer. An auto-complete feature can provide the developer with a selection of various destinations, which may include different destination types, when a partial identification is entered into the search element. Other advantages and features of the invention are described below.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2004, Microsoft Corp.

### FIELD OF THE INVENTION

This invention relates to software development, and more particularly to navigation between the many different items available in an integrated development environment (IDE).

### BACKGROUND OF THE INVENTION

Modem software is typically created with a great deal of computer automated assistance. Such assistance is commercially available in a variety of software, generally referred to as integrated development environments (IDEs). For example, MICROSOFT'S VISUAL STUDIO®, BORLAND'S C++ BUILDER®, METROWERK'S CODE WARRIOR®, and IBM'S WEBSPHERE STUDIO® are all products presently available to assist in software creation. Such products provide a range of useful functions, such as coordinating communications between multiple developers working together on large projects, assisting in the actual writing of source code, assisting in specifying how a source code file will be compiled, and providing compilers and other processes that convert a source code files and the like into executable files.

The process of developing software using an IDE is depicted in FIG. 1a. First, the software can be designed using a design tool 100. The design tool 100 will typically provide a wide range of design functions for generating any number of files 110a-110h. Files 110a-110h may be files of a variety of types. Some may be files containing source code, while others are files that specify some other properties of the software under development. When the files 110a-110h for a software application are ready, they may be passed to what is known as a build process 120. Many IDEs have built-in build processes 120. While some IDE products may bifurcate the creation of the files 110a-110h and the build-process 120, others provide software design and build as options through a single user interface.

The build process 120 may comprise any number of sub-processes 121-124. One such sub-process is typically a compiler 121. A compiler 121 is software that provides a function of reading source code and generating binary files, which may be computer-executable, or near-computer-executable files. Another build process is a linker 122. A linker supplies the appropriate location references within executable files 145, 146, 147. A plurality of properties desired for executable files 145, 146, 147 may be stored in one or more files 131-134 available to the build process 120. Thus, when the time comes to convert the original files 110a-110h into executable files 145, 146, 147, the build process has access to the build property files 131-134 governing how the build is to be conducted.

A solo developer may run an IDE on a personal computer, and perform all of the above steps on a single machine. In another scenario, a team of developers may work together on an application. In this scenario, the network of collaborating developers may look similar to FIG. 1b.

As suggested by the FIG. 1b, a central server 150 may be used to coordinate the efforts of a number of developers using client devices 149, 155, 160, 165. The developers may each have a variety of responsibilities in implementing aspects of a large software application. It is important that the various aspects of software work together properly. It is also preferable to ensure centralized control over a software application, so that developers cannot inadvertently alter the application without approval through the proper channels. Without such centralized control, the development environment can quickly become one in which there are many copies of an application, each with differing features, and it becomes impossible to move forward with production.

Thus the central server 150 is frequently called a “Source Code Control” (SCC) engine 150. The means by which most SCC engines 150 coordinate development is through sync and check-in procedures. When a developer first retrieves existing software under development from the SCC engine 150, it is called a sync 151. A sync 151 creates a copy of the application on the developer's client computer 149. This provides the developer with an official copy of the application under development, so he or she can work with the existing features of the application. A check-in 152 occurs when the developer returns his or her modifications to the SCC engine 150; and thereby updates the official version of the application under development. A set of modifications may be subject to review prior to check-in 152. If the modifications made by a developer conflict with other modifications, then the modifications may have to be scrapped.

FIG. 1c presents a simplified Graphic User Interface (GUI) 171 for an exemplary IDE, with many elements that are familiar to those of skill in the art as well as most modern computer users. A plurality of selectable menu elements 172-180 allow for navigation to various functions, file destinations, tool windows, application settings, and the like. A workspace 185 presents the contents of one or more open files that can typically be modified from the GUI 171. A directory tree 181 may allow navigation to the many files associated with software under development. To find a file using a directory tree, a user can first select the most general directory level containing the file, e.g., the “source” level in FIG. 1c. The user may then proceed to select from the categories presented, e.g., “sub 1b,” then “sub 1biv,” then “sub 1bivC,” and so on until a desired file is uncovered. The files in a directory tree 181 may reside locally on a client device, such as 165 in FIG. 1b, or on a central server 150, on some other client device, e.g., 155, or at any other networked location.

The number of files in the directory tree 181 may grow to be enormous, especially in the case of many developers working together on a large software application. With a large number of files categorized in various locations in the directory tree 181, there is a risk that a developer may not remember the path to a desired file, or that the developer will waste time finding a desired file. To assist in the speedy navigation to a desired file, an IDE GUI 171 may provide a way to automatically search for a file, such as the file search element 182 in FIG. 1c. Using the file search element 182, a developer can type identification information in the entry space 183, and execute the search by selecting 184 or by depressing the “enter” key. An automated search process will automatically find the identified file from the files in the directory tree 181.

Typically, the file search element 182 contains a character entry space 183 for typing the name of the desired file, and a button 184 for initiating a search. The search element 182 can be incorporated into the GUI 171 in a variety of ways, such as a permanently available search box included with the other menu items 172-180, or as a floating window, as illustrated in FIG. 1c. If a floating window, the search element can be accessed by first navigating to a search function through the menu items 172-180, or by depressing a combination of shortcut keys, e.g., “shift+F4.” In the interest of saving time, most developers learn the shortcut keys to open a file search element 181 rather than navigating through the menu items 172-180.

There are many destinations in addition to the files in a directory tree 181 that developers may wish to locate. Some of the most common additional destinations are lines of source code within a file, symbols or members of a particular class in source code, bookmarks placed in source code or other locations by a developer, and tool windows. Presently, each of these various destination types, if they can be searched for at all from an IDE GUI, are searchable only from separate search elements. In other words, presently available file search elements such as 182 cannot be used to search for a tool window, a line of source code, or anything other than a file. In order to search for a desired tool window, a developer must presently either navigate through the selectable menu elements 172-180 for the desired tool window, or remember a shortcut key for a tool window search element. To save time, many developers presently memorize a large number of shortcut key combinations for opening appropriate search elements to conduct the various common searches they perform.

FIGS. 1d-1h are a series of flowcharts that demonstrate the minimum required action to conduct a search for various common destination types. Each flowchart 1d-1h includes a first step of opening an appropriate search element 190a-194a, a second step of entering an appropriate identification 190b-194b, and a third step of executing the search 190c-194c. Because each destination type presently requires a separate search element, the steps in flowcharts 1d-1h cannot be combined. The burden of remembering how to open a search element for a particular destination type is placed on the developer. This burden entails first discovering the existence of the search element features for an IDE, second consciously remembering the various different shortcut key combinations, third determining what kind of destination type is involved prior to invoking a search.

In light of the above described deficiencies in the art, there is a need in the industry to provide systems and methods to streamline and facilitate navigation to various destination types in IDE GUIs.

### SUMMARY OF THE INVENTION

In consideration of the above-identified shortcomings of the art, the present invention provides systems and methods for navigating to multiple destination types from a single search interface element in an Integrated Development Environment (IDE) Graphical User Interface (GUI). Exemplary destination types are files, lines of code, symbols, bookmarks, and tool windows. An algorithm can be used to automatically determine a likely destination type from any characters entered into a search element. The automatically determined destination type can be prioritized in the search. The burden of specifying an appropriate type of search element is thus shifted away from the developer. An auto-complete feature can provide the developer with a selection of various destinations, which may include different destination types, when a partial identification is entered into the search element. Other advantages and features of the invention are described below.

### BRIEF DESCRIPTION OF THE DRAWINGS

The systems and methods for navigating to multiple destination types through a single search interface element in a development environment are further described with reference to the accompanying drawings in which:

FIG. 1a illustrates the prior art software development process, as may be supported by Integrated Development Environment (IDE) software, in which a plurality of files 110a-110h are created with a design tool 100, then converted into executable files 145-147 by a build process 120, and where the build process draws on a second set of files 131-134 to determine various properties of the output computer executable files 145-147.

FIG. 1b illustrates a typical prior art collaborative software development environment, in which a plurality of software developers coordinate their efforts through a central server.

FIG. 1c illustrates a prior art IDE Graphical User Interface (GUI) with a directory structure 181 for locating files and a floating window search element 182 that can search for one destination type, such as files.

FIG. 1d illustrates a prior art sequence of steps required for navigating to a file using a file search element in a GUI. The file search element GUI cannot be used for any other destination type.

FIG. 1e illustrates a prior art sequence of steps required for navigating to a code line using a code line search element in a GUI. The code line search element GUI cannot be used for any other destination type.

FIG. 1f illustrates a prior art sequence of steps required for navigating to a symbol using a symbol search element in a GUI. The symbol search element GUI cannot be used for any other destination type.

FIG. 1g illustrates a prior art sequence of steps required for navigating to a bookmark using a bookmark search element in a GUI. The bookmark search element GUI cannot be used for any other destination type.

FIG. 1h illustrates a prior art sequence of steps required for navigating to a tool window using a tool window search element in a GUI. The tool window search element GUI cannot be used for any other destination type.

FIG. 2a is a block diagram broadly representing the basic features of an exemplary prior art computing device suitable for use in conjunction with various aspects of the invention;

FIG. 2b is a block diagram representing a more detailed exemplary prior art computing device suitable for use in conjunction with various aspects of the invention;

FIG. 2c illustrates an exemplary prior art networked computing environment in which may computerized processes, including those of the invention, may be implemented;

FIG. 3 illustrates an IDE GUI with a floating window serving as a search element 300 for navigating to multiple destination types.

FIG. 4 provides a flowchart with a set of steps for carrying out a search for any two or more destination types when using the systems and methods of the invention.

FIG. 5 provides a detailed view of an exemplary search element 500 for use in connection with the present invention. The exemplary search element 500 can comprise an auto complete feature 502, and can perform searches for a plurality of destination types 550-554.

FIG. 6 illustrates an exemplary algorithm for determining a priority ranking among destination types to automatically search for. FIG. 6 can also serve as an exemplary algorithm for determining a priority of search results, if multiple results are returned, and for determining a priority of completion selections if more than one destination matches characters entered in the character entry area.

FIG. 7 provides various exemplary embodiments of an entire contemplated software system sufficient to implement the invention.

FIG. 8 illustrates steps that can be undertaken in various embodiments of the invention to access a file destination type from a search element that provides access to multiple destination types.

FIG. 9 illustrates steps that can be undertaken in various embodiments of the invention to access a code line destination type from a search element that provides access to multiple destination types.

FIG. 10 illustrates steps that can be undertaken in various embodiments of the invention to access a symbol destination type from a search element that provides access to multiple destination types.

FIG. 11 illustrates steps that can be undertaken in various embodiments of the invention to access a bookmark destination type from a search element that provides access to multiple destination types.

FIG. 12 illustrates steps that can be undertaken in various embodiments of the invention to access a file, code line, symbol, or bookmark destination type from a search element that provides access to multiple destination types.

FIG. 13 illustrates steps that can be undertaken in various embodiments of the invention to access a tool window destination type from a search element that provides access to multiple destination types.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Overview

The following detailed description will generally follow the summary of the invention, as set forth above, further explaining and expanding the definitions of the various aspects and embodiments of the invention as necessary. In general, navigation is a core component of any IDE. The invention can be used to make navigation much simpler. Improvements to navigation make developers more productive in their day to day development activities.

Embodiments of the invention can provide a one-stop shop for a developer navigating around source code and tool windows. As a developer is coding, he/she can bring up a single window to perform any type of source code or tool window navigation. The developer can type in a number or a string representing a file name, a code line number, a symbol, a bookmark name, or any other source code destination. A supporting navigation engine can then automatically detect what type of navigation the developer is trying to perform, and offer completion of the number or string that the developer is entering.

Embodiments of the invention can provide completion options by accessing various data stores that may be associated with the software under development. When a developer selects a desired destination, the navigation engine can use the appropriate navigation technique to locate and display the destination. If a non-unique destination is entered, the navigation engine can navigate to a most probably desired location. For example, if a string is entered that matches a part of a file name as well as a symbol defined in a project, the navigation engine may determine that the file is the more likely desired location, and display the file location.

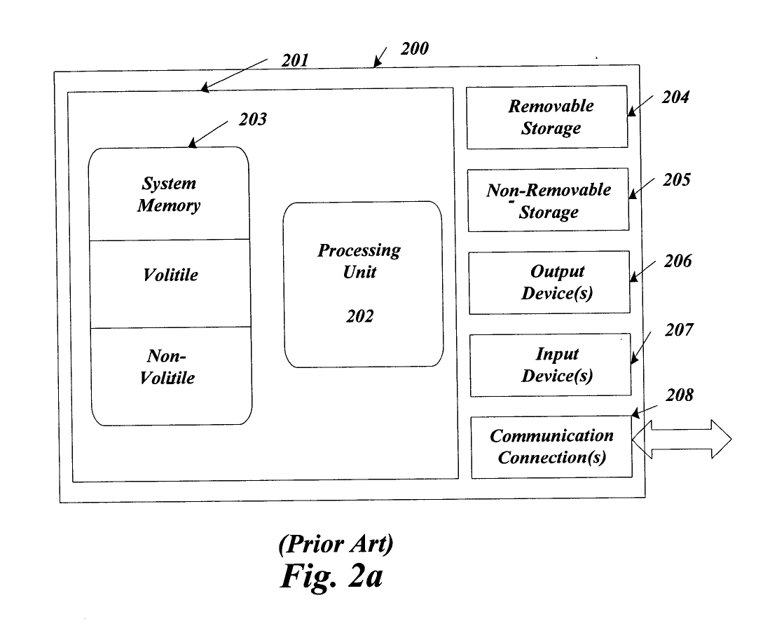

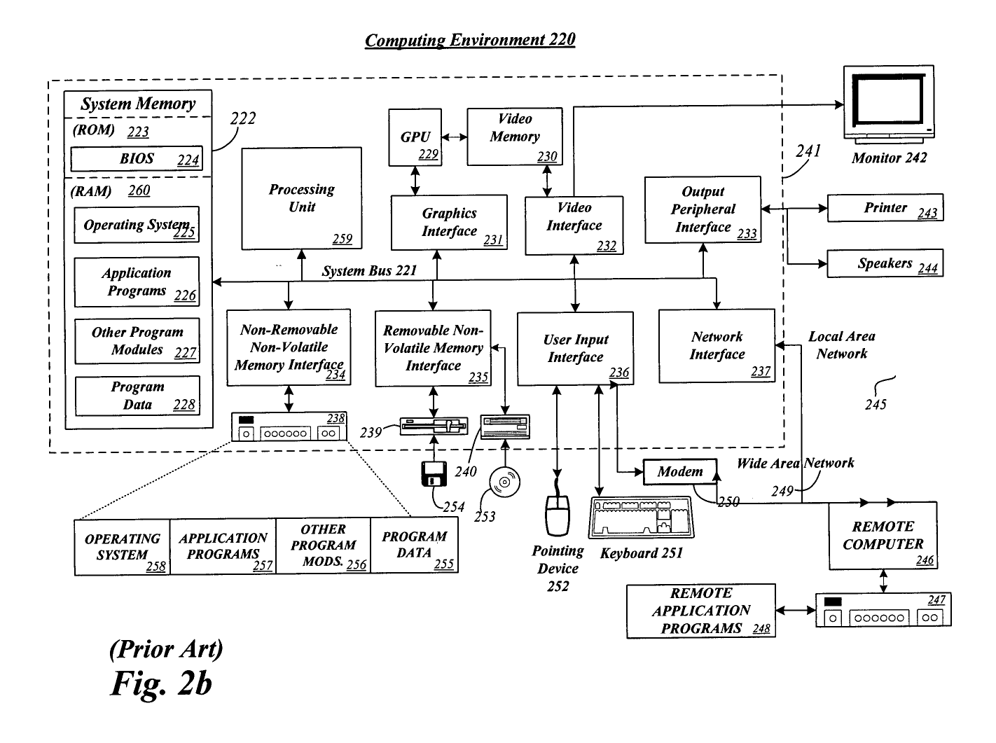

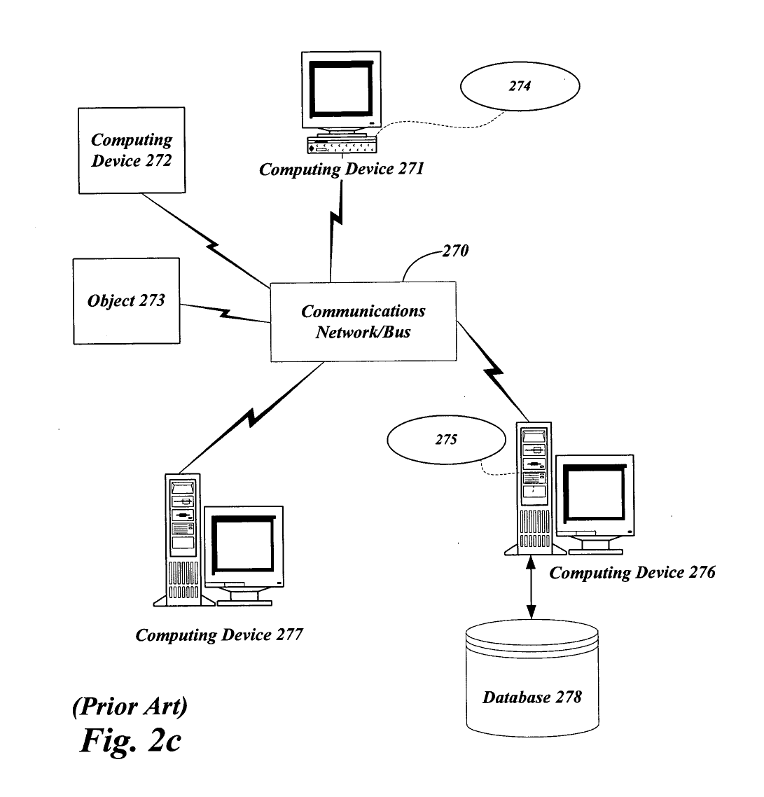

FIGS. 2a, 2b, and 2c provide a prior art computing and networked environment which will be recognized as generally suitable for use in connection with the systems and methods set forth herein. Because the material in FIGS. 2a, 2b, and 2c is generally known in the art, the corresponding description is reserved for the end of this specification, in the section entitled “exemplary computing and network environment.”

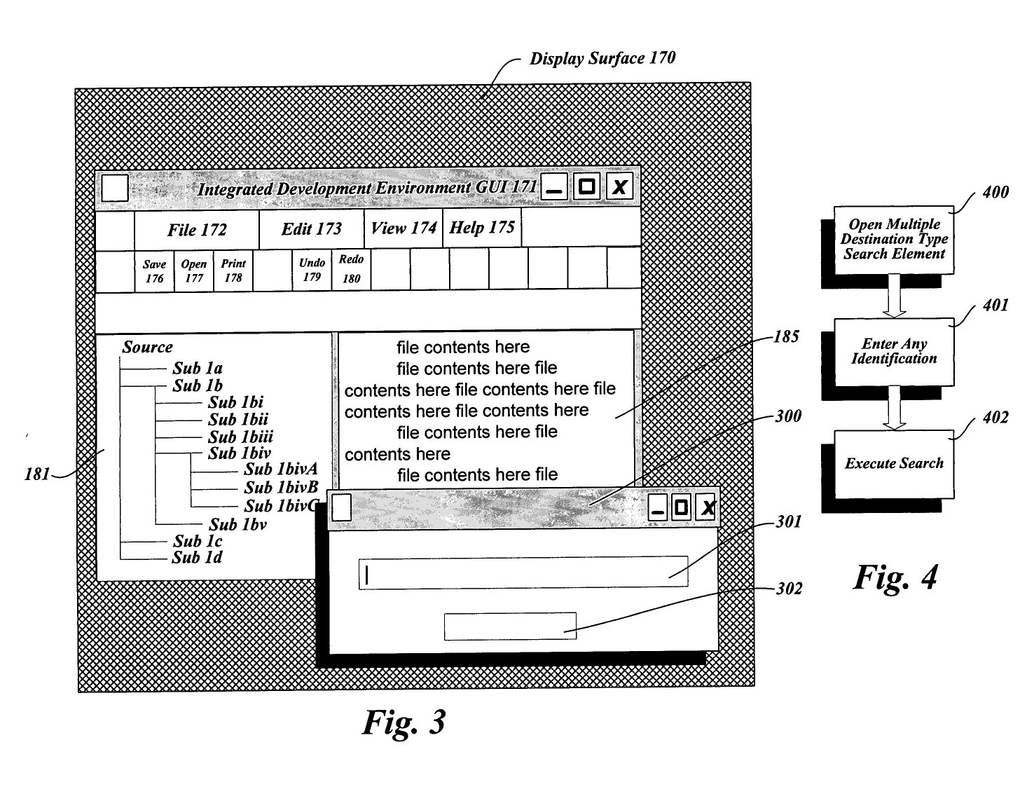

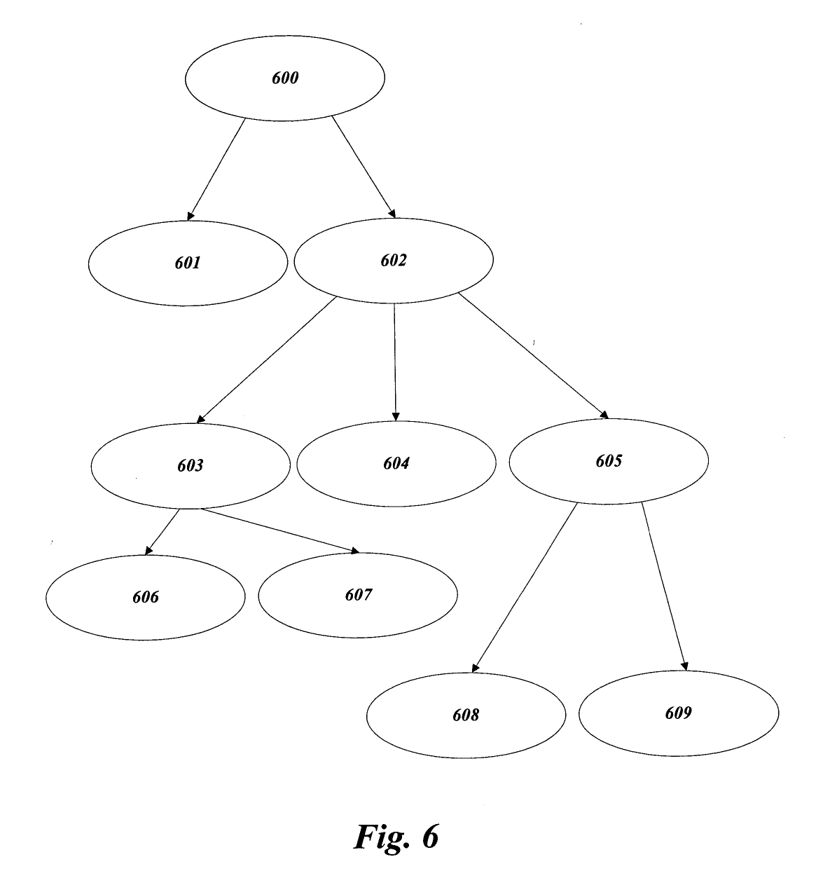

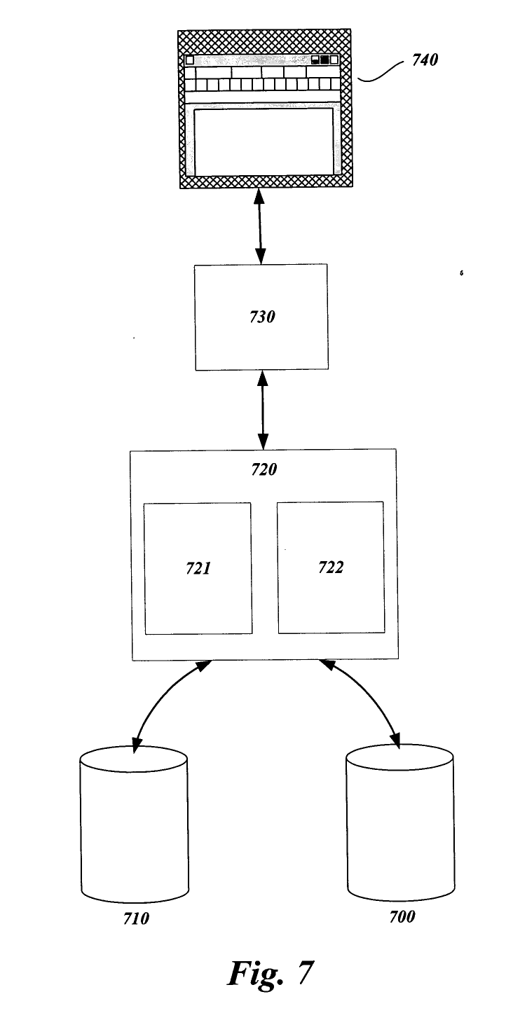

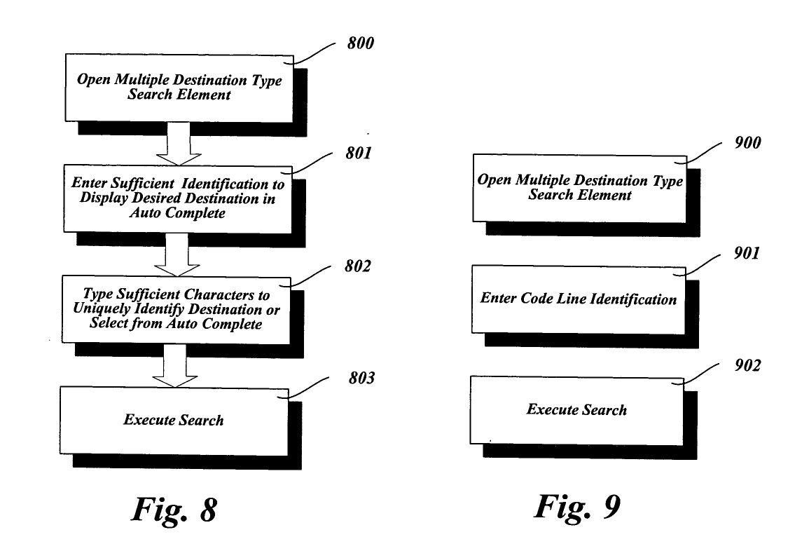

First described herein is a search element for navigating to multiple destination types is set forth in connection with FIGS. 3, 4, and 5. The auto-complete feature and prioritization of the destination types to search are also discussed with reference to FIGS. 3, 4, and 5. Next, an exemplary algorithm for determining the priority of destination types to search is described with reference to FIG. 6. FIG. 7 then provides various exemplary embodiments of an entire contemplated software system sufficient to implement the invention. Finally, a series of flowcharts are presented in FIGS. 8-12 demonstrating the steps that may be carried out to search for the various destination types using the single search element of the invention.

### DETAILED DESCRIPITON OF ASPECTS OF THE INVENTION

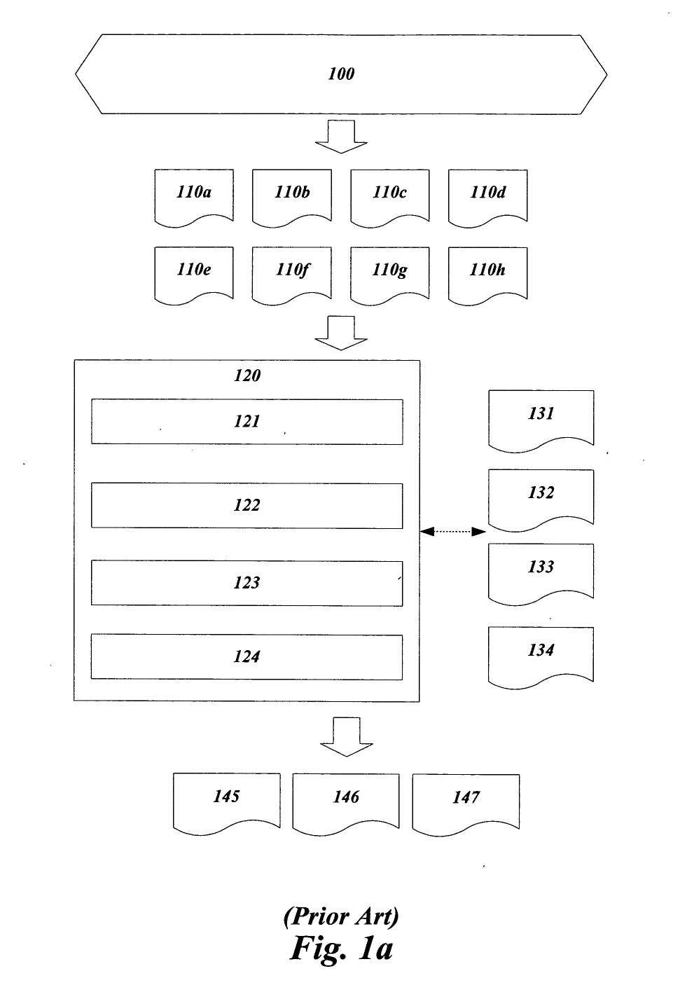

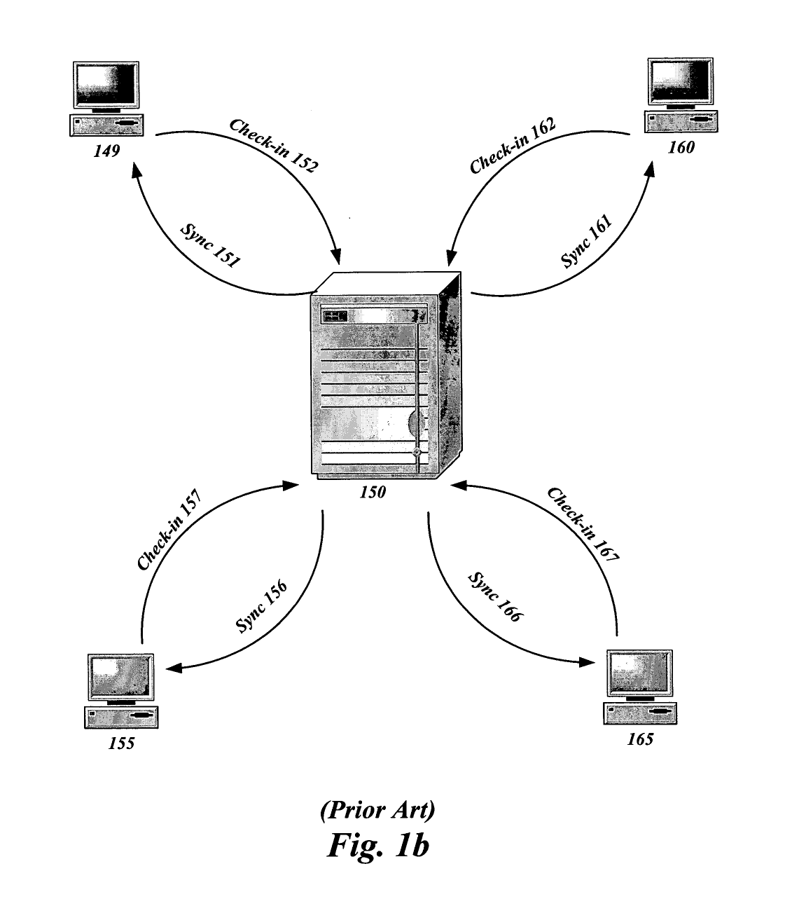

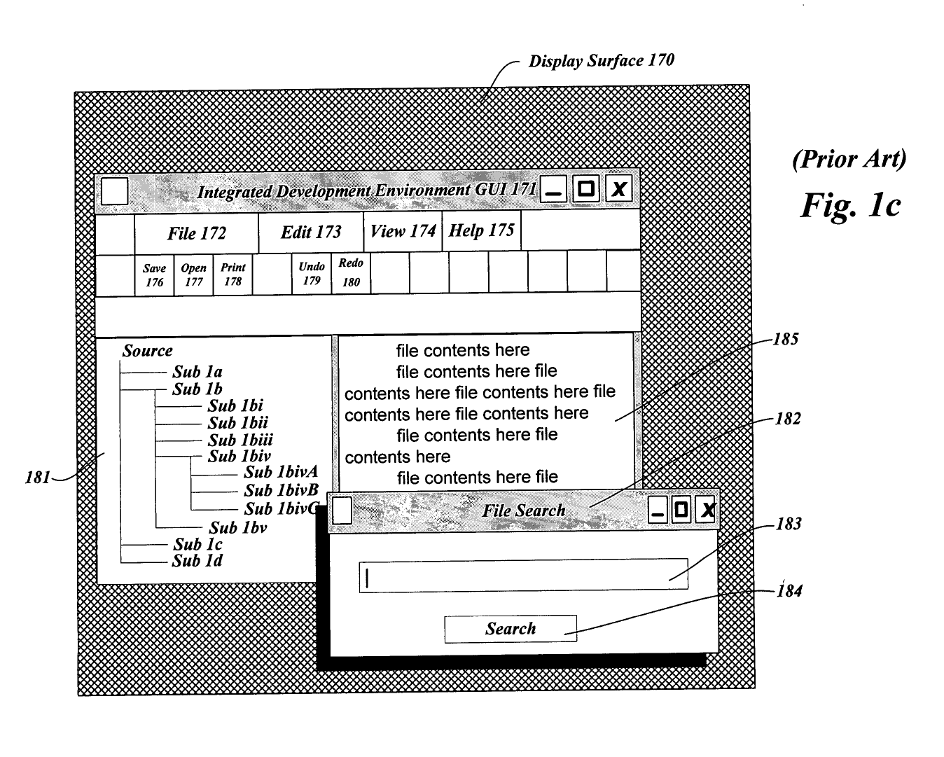

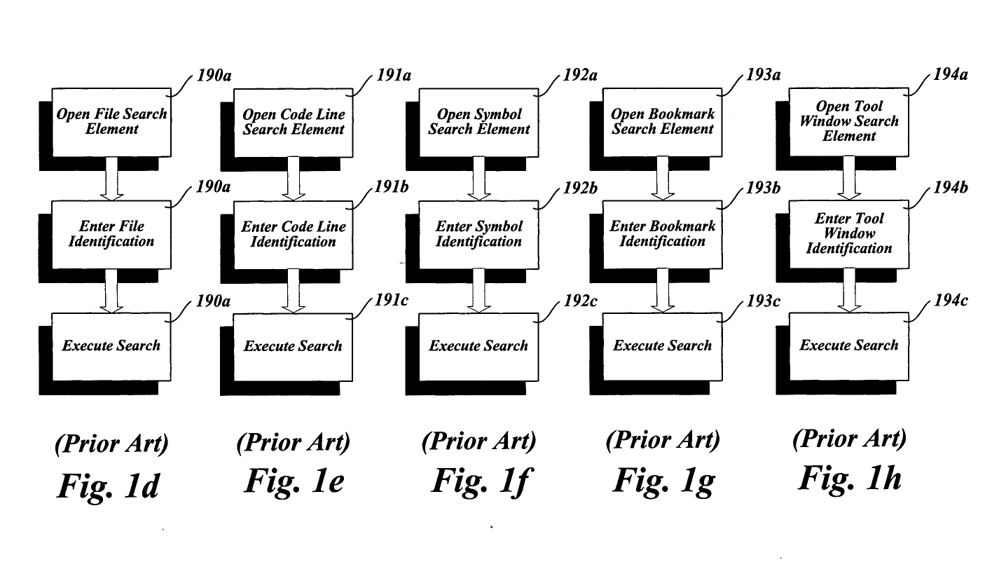

FIG. 3 illustrates an IDE GUI with a floating window serving as a search element 300 for navigating to multiple destination types. Many of the GUI elements in FIG. 3 are identical to those of FIG. 1c, to emphasize that embodiments of the invention can be used in the setting of presently available IDEs. The aspects unique to the invention in FIG. 3 are the exemplary search element 300 comprising the character entry area 301 and search execution element 302.

Characters may be entered into character entry space 301 that identify more than one destination type. For example, a file name could be entered in the character entry area 301, and the search could be executed by selecting 302 or depressing the “enter” key. The supporting navigation engine could then navigate to the identified file. At a later time, a code line identifier could be entered into the character entry area 301, and the search again executed. The supporting navigation engine could then navigate to the identified code line. Moreover, an identifier that matches both a file name and another destination, e.g., a bookmark name, could be entered into the character entry area 301, and the search again executed. The supporting navigation engine could then navigate either to the first matching destination, or to the second matching identification. The navigation engine can contain appropriate processes for determining the destination type or prioritizing among destination types, which will be explained further below.

While preferred embodiments of the invention provide a search element 300 which can manage all common destination types, other embodiments may find reason to limit the implementation of the invention to only two, three, or other limited number of destination types. For example, some embodiments of the invention may provide an IDE with two search elements: a first for navigating to files and code lines, and a second for navigating to symbols, bookmarks, and tool windows. Each of the search elements in such an embodiment would make use of the invention, because each allows search of more than one destination type.

Search element 300 is presented in FIG. 3 as a floating window. The floating window is a common embodiment for prior art search elements, and is typically opened by depressing the appropriate shortcut keys, or by navigating to an appropriate menu item for invoking a search. Either of these techniques or any other available technique may be used in connection with the invention, as it is not limited to any particular technique for invoking the search element.

Other embodiments of a search element 300 can be, for example, that of a permanent menu item in the toolbar space of an IDE GUI, occupied in FIG. 3 by selectable elements 172-180. In this embodiment, a character entry space similar to 301 and selectable search execution element similar to 302 may be made permanently available in the toolbar space. Alternatively, the search element 300 could be presented as a sidebar on one of the sides, or the top or bottom, of the area occupied in FIG. 3 by the workspace 185 and directory 181. The invention is not limited to the location or orientation of the search element 300.

FIG. 4 provides a flowchart with a set of steps for carrying out a search for any two or more destination types when using the systems and methods of the invention. Compare the single flowchart, and corresponding single set of steps 400, 401, 402 with the five flowcharts and corresponding five sets of steps set forth in FIGS. 1d-1h. This illustrates a difference between the invention and the prior art: while the prior art required a separate initiation method for search sequences relating to each different destination type in an IDE GUI, the invention can be used to condense the various initiation methods to allow one initiation method to launch a search that can navigate to multiple destination types.

To clarify the illustration of FIG. 4, note that multiple searches, regardless of whether the search is for the same or different destination type as a prior search, may still require a developer to perform multiple cycles through the steps of FIG. 4. However, each time the developer initiates a new search, he/she can perform the same action, be it depression or shortcut keys or otherwise, to begin the process. Thus, the language herein referring to a single search method or single search element that can be used to navigate to, or cause display of, multiple destination types such as files, code lines, and the like should be interpreted to refer to the multiple use of the method or single search element. The intended meaning is not that the single search element simultaneously navigates to multiple items, although such embodiments may be possible, but rather that the same method or search element can be re-used—first to locate an item of a first type and next to locate an item of another type.

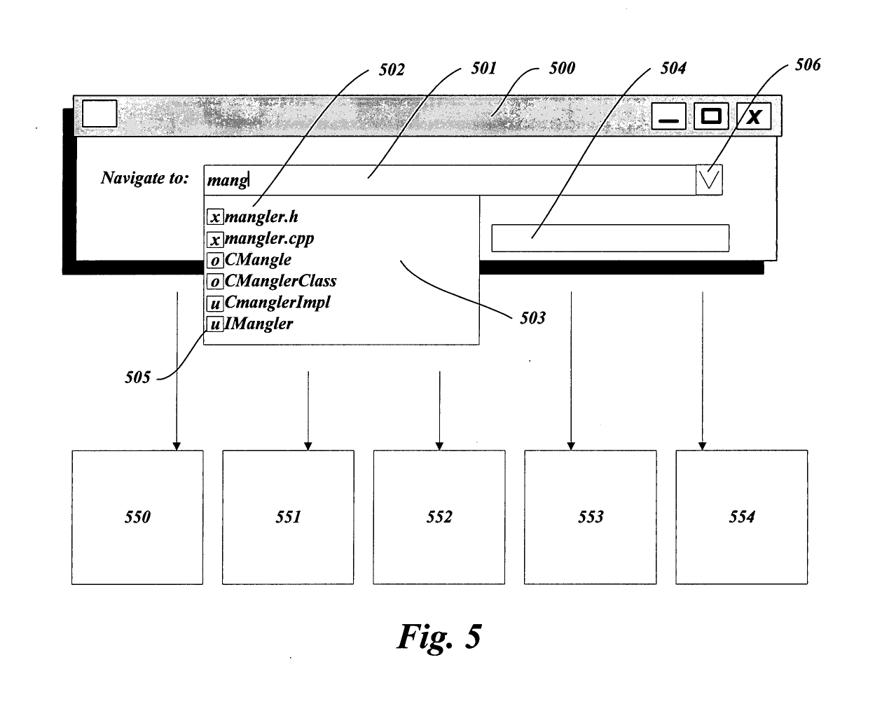

The steps of FIG. 4 begin with opening a multiple destination type search element 400. The search element referred to is the interface depicted as 300 in FIG. 3 and again as 500 in FIG. 5. Note that this first step may be unnecessary if the multiple destination type search element is permanently available in IDE GUI. Such embodiments are perfectly acceptable. To save space in the GUI, however, other embodiments may require step 400 in order to initiate a search.

The next step is to enter any identification 401. This refers to entering identification information in a character entry area. Identification information can be entered via a range of techniques, such as cutting and pasting, or typing characters directly. In general, identification information will comprise numbers, letters, or a combination of both. An entry that consists of numbers, such as 1234 or 4321.01 is referred to in the industry as an integer, while an entry that comprises letters or a combination of letters and numbers, such as foo.cpp, or foo123 is generally referred to as a string.

While the identification entered will ultimately be used to navigate to a unique location, the original identification may not be unique. In such cases, the search element can be equipped with an auto complete to offer a plurality of unique completion options. Alternatively, the search can be configured to prioritize some navigation destinations over others. The navigation engine that supports the search element can use a range of techniques to determine what destination types will be located for a given search. For example, if an integer is entered in the character entry area, there is a high probability that the developer is searching for a line of code in an open file. Thus, the navigation engine can be configured to prioritize code lines in searches that provide integers. This will be discussed in further detail in connection with FIG. 6.

The final step in FIG. 4 is to execute the search 402. The presently accepted ways for executing an action from an open GUI element are, first, to select a selectable execution element, such as 302 in FIG. 3, and, second, to depress the “enter” key. Either of these methods for executing the search are acceptable for use with the invention, as are any other methods that may be developed or come into common practice. The invention is not limited to any particular method for executing a search.

FIG. 5 provides a detailed view of an exemplary search element 500 for use in connection with the present invention. The exemplary search element 500 can comprise an auto complete feature 502, and can perform searches for a plurality of destination types 550-554.

The auto complete feature may provide any number of identification completions, e.g., the exemplary completions “mangler.h,” “mangler.cpp” and so on in FIG. 5, when a partial identification, e.g., “mang,” is entered in the character entry area 502. A favored completion can be highlighted, such as 503. In preferred embodiments, the favored completion can be selected using the arrow keys of a keyboard, and the favored completion can be entered in the character entry area by depressing the “tab” key. Moreover, icons such as 505 may be placed next to the various completions presented, indicating the destination type the completion. For example, an icon representing a file can be placed next to all completions that give a file name. An icon representing a line of code can be placed next to all completions that give a line of code, and so on. Another auto-complete feature can be the drop-down list element 506. When a drop-down list element 506 is selected, a list of previously conducted or frequently conducted searches can be provided. The invention is not limited to these exemplary features for auto complete.

The plurality of destination types that may be searched using the single search element 500 are displayed as 550-554. Each of 550-554 can represent a data store comprising items of a unique destination type. For example, 550 could be a list matching file identifiers to file locations, 551 could provide such a list for code lines, 552 could be for symbols, 553 could be for bookmarks, and 554 could be for tool windows. Alternatively, some destination types, e.g., code lines and bookmarks, may be kept in the same data store, e.g., 551, thereby allowing a properly conducted single search of the data store 551 to operate as a search for multiple destination types. Modern database technologies allow for storing data in a wide variety of ways, and the invention is not limited to implementations involving discrete, separate data stores. Perhaps more likely, all of the destination types may be stored in a single database and queried using one or more queries that can identify a set of one or more destination types.

The auto complete feature 502 may present a plurality of destinations, which may be of one or more destination types. For example, a first two completions offered by auto complete may be files, while a next two are symbols, and so on. In this regard, the data stores 550-554 with various destination types may be queried as characters are entered in the character entry area, to retrieve candidates for identification completion. Another source for generating auto complete options can be a specialized data store that tracks a history of items frequently used by a particular developer. This will be discussed further with reference to FIG. 7.

FIG. 6 illustrates an exemplary algorithm for determining a priority ranking among destination types to automatically search for. FIG. 6 can also serve as an exemplary algorithm for determining a priority of search results, if multiple results are returned, and for determining a priority among results if more than one destination matches characters entered in the character entry area. The following brief discussion will be directed first to determination of a priority of destination types to search for, next to determination of priority in auto-complete selections, and finally to determination of priority among results to return.

When characters are entered into a character entry area, such as 501 in FIG. 5, and a search is executed, for example by depressing the “enter” key or by selecting a selectable element such as 504 in FIG. 5, the characters entered are searched for by the navigation engine. The locations that are searched presumably contain information for navigating to various destination types. The particular locations that are chosen to be searched can be all locations, or a subset of likely locations that is determined based on the identification information entered. In either case, a priority of locations may be calculated to make the search more efficient.

The determined priority can rank order the various locations to be searched. For example, by first searching for code lines, then file names, then bookmarks, and so forth. The priority can also eliminate several destination types altogether. For example, it may be determined that some character identifications correspond only to predictable destination types, and all locations not corresponding to such destination types can be eliminated. In other embodiments, the determined priority may comprise a first, most likely location for search, and a subsequent search of all other locations without priority.

Referring back to FIG. 6, the first location to be searched may be arrived at using the illustrated decision tree. A first property of the characters entered can be examined in 600. If the characters have the first property, then the next step can be 601. If the characters do not have the first property, then the next step can be 602. For example, the first property to be examined may be to query whether the identification information, or characters, entered is an integer. If it is, then it may be likely that the locations to be searched can be limited to a subset, such as code lines only. This limitation may be reflected by step 601. 601 may provide, for example, a search of an open file for the integer entered. If the identification information is not an integer, however, then it may be likely that the locations to be searched can be limited to a different subset, such as bookmarks, tool windows, symbols, and file names. Step 602 may provide another examination of the identification to further narrow the search. The remaining elements in FIG. 6, e.g., 603-609 illustrate a random set of additional steps that may be performed to limit the search, and thereby determine a priority for search, as described above. The invention is not limited to any particular technique for prioritizing the search locations, because new naming conventions may arise for the various items, leading to new steps in the decision tree.

Auto-complete selection priority can also be determined using an algorithm such as that illustrated in FIG. 6. As a user begins typing characters, an auto-complete process can begin determining a set of destinations that match the characters. These destinations can be presented in a box beneath the character entry area, such as 502 in FIG. 5. A priority of the destinations presented may be reflected by positioning the various destinations within 502. For example, if a first destination is more likely the one that a user will want, this first destination can be placed at the top of 502, the position occupied by “mangler.h” in FIG. 5. The priority of the various destinations can be visually reflected by any other means as well, for example by ordering from bottom to top or side-to-side, or using colors, numbers, or other markings to reflect a priority.

Finally with reference to FIG. 6, a priority among results to return can be determined by a process such as that of FIG. 6. A user may enter characters that identify several destinations. Referring briefly to FIG. 5, the “mang” entered in 501 presumably identifies all of the destinations in 502. Suppose the user does not choose an auto-complete selection, and instead simply executes the search. In this scenario, some embodiments of the invention may be configured to force the user to choose a unique destination that is desired, while other embodiments may present all of the destinations matching the identification, for example in a new floating window providing search results. Still other embodiments may simply pick a top-priority destination matching the entered identification, and navigate to the chosen destination. In determining a priority, some of the steps 600-609 may be configured to assign a priority as well as a search location. For example, step 601 could assign a top search priority to code lines for any identifications that are an integer, while step 602 could assign a bottom priority to code lines for those identifications that are not an integer, in addition to examining some other aspect of the identification for further prioritization.

FIG. 7 provides various exemplary embodiments of an entire contemplated software system sufficient to implement the invention. Identification information can be entered into a search element portion of a GUI on a visual surface 740. The identification information may be interpreted by a first process 730 and passed to a navigation engine 720. The navigation engine 720 can comprise a search engine 721 and an auto complete engine 722. Both 721 and 722 can access data stores 700, 710 to find the appropriate destination information to return to the GUI 740.

The search engine 721 can use the identification information entered in a character entry area, and determine a destination to return. The determination of a destination, in accordance with the systems and methods provided here, may be made by either prioritizing a destination type, as described with reference to FIG. 6, or by searching multiple destination types at once. The destination types contemplated for use with the invention comprise file names, code lines, symbols, bookmarks, and tool windows, but it should be emphasized that additional destination types may be added to this list in accordance with the description of the invention provided herein.

Once a destination has been determined by the search engine, the destination may be returned in a variety of ways. The manner of returning a destination may depend on the destination type. For example, if a code line is the destination type, the search engine 721 may locate the code line in an open file, and then the navigation engine 720 can move the cursor to the identified code line. The user would see the workspace change to present the area of a file containing the specified code line. If a code line in a file that is not open is identified, the navigation engine 720 could open the appropriate file in a GUI workspace such as 185 and place the cursor at the identified code line.

If a file name is identified, the search engine 721 may find the file, and then the navigation engine 720 may navigate to the file in a GUI directory structure 181 from FIG. 3. The navigation engine could highlight the file in the GUI. Alternatively, the navigation engine 720 could open an identified file and present it in a workspace 185. In various other embodiments, the identified file could be presented in a floating window opened for that purpose, or in some other location in the GUI.

If a symbol is identified, a navigation engine 720 could open the file containing the symbol, and place the cursor at the beginning of the portion of the file representing the symbol. Similarly with a bookmark, the appropriate file can be opened, presented in a workspace 185, and presented such that the portion of the file with the bookmark is in the workspace.

A tool window destination may also be presented by the navigation engine 720 in a variety of ways within a GUI after the tool window is located by the search engine 721. for example, the tool window may be presented as a floating window, by opening a GUI frame with the tool window, or by presenting a new toolbar with the appropriate tools for the tool window.

The data sources 700, 710 can be any data sources. In various preferred embodiments, the data sources 700, 710 are databases. A first data source 701 may comprise data that is dynamically stored based on the actions of a developer when developing a particular software application. This data source 701 may comprise, for example, all of the destinations navigated to by a developer. It may also rank the destinations based on a number of times that the developer has navigated to them, and based on a most recent navigation to the destinations. This information may be used to determine the most likely destinations that a developer may wish to access for any given use of the single search element. Destinations that the developer navigates to frequently are more likely to be a destination for a search than destinations that are infrequently selected.

A second data source 700 may comprise an editor data store for a particular project. This data source may comprise any and all data that a developer may desire for a particular project. The invention is not limited to any particular number or type of data sources 700, 710.

FIGS. 8-12 illustrate exemplary steps that can be undertaken in various embodiments of the invention to access a desired destination type from a search element that provides access to multiple destination types.

Referring first to FIG. 8, exemplary steps are provided for using the search element to navigate to a file. First, a developer may open a search element capable of navigating to a variety of destinations 800. Next, the developer may type in sufficient identification information to bring up a set of completion options that includes the desired destination 801. At this point, the developer can either type enough characters to make the string a unique identifier for the desired destination, or use the arrow keys to select a desired file from the options presented by auto complete, and the tab key to enter the selection in the character entry area 802. Finally, the developer can strike the “enter” key or execute the search by other means 803. In response to executing the search, the identified file may be located and presented, which may include opening the desired file.

Consider an example of the above process illustrated in FIG. 8. A developer wants to navigate to a file named “browser.cpp”: The developer opens the search element 800 and types “brow” 801. They may see completion options with all files containing “brow” from a current project, other projects in the solution, include path and current working directory for ‘devenv.exe’. They may also see some symbols containing “brow” in the completion list. They type enough characters to make the string a unique hit or use the arrow keys to select a matching file 802. When they hit <Enter> 803, the file is opened.

Referring to FIG. 9, exemplary steps are provided for using the search element to navigate to a line of source code in an open and active file, namely a file currently displayed in a workspace. First, a developer may open a search element capable of navigating to a variety of destinations 900. Next, the developer may type the desired line of source code 901. Finally, the developer can strike the “enter” key or execute the search by other means 902. In response to executing the search, the line from the currently open file may be located and presented.

Consider an example of the above process illustrated in FIG. 9. A developer wants to go to line 19 of the current source file. The developer simply opens the search element 900 and types “19” 901. When they hit <Enter> 902, the desired line of the current file is displayed.

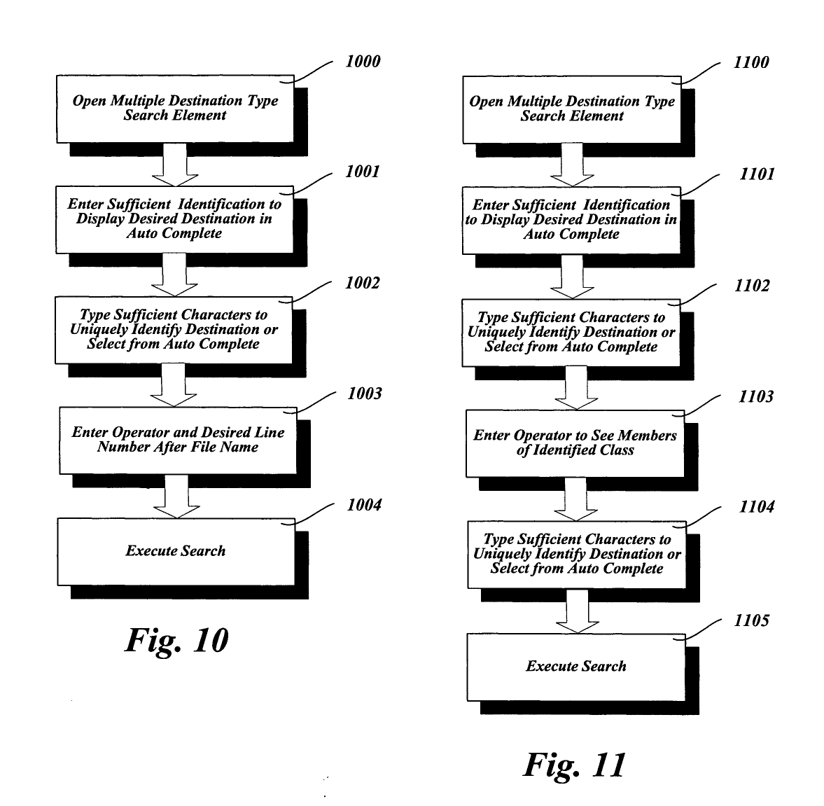

Referring to FIG. 10, exemplary steps are provided for using the search element to navigate to a line of source code in a file that is not currently active. First, a developer may open a search element capable of navigating to a variety of destinations 1000. Next, the developer may type in sufficient identification information to bring up a set of completion options that includes the desired destination 1001. The desired file may be automatically prioritized and highlighted. At this point, the developer can either type enough characters to make the string a unique identifier for the desired destination, or use the arrow keys to select a desired file from the options presented by auto complete, and the tab key to enter the selection in the character entry area 1002. Next, the developer can type a colon or other operator, followed by the desired line number within the file that he wishes to access 1003. Finally, the developer can strike the “enter” key or execute the search by other means 1004. In response to executing the search, the identified file may be located and presented, which may include opening the desired file and presenting the portion of the file with the desired line number.

Consider an example of the above process illustrated in FIG. 10. A developer wants to go to line 19 a file named browser.cpp, which is not the currently active file: The developer simply opens the search element 1000 and types “brow” 1001. He or she sees the completion list with “browser.cpp” (highlighted) and, for example, another file named “browser.h.” The developer depresses the <tab> key to complete the string to “browser.cpp,” 1002 then types “:19” 1003 and depresses the “Enter” key 1004. In response, the desired line of the indicated file is displayed.

Referring to FIG. 11, exemplary steps are provided for using the search element to navigate to a symbol. First, a developer may open a search element capable of navigating to a variety of destinations 1100. Next, the developer may type in sufficient identification information to bring up a set of completion options that includes the desired destination 1101. The desired class may be automatically prioritized and highlighted. At this point, the developer can either type enough characters to make the string a unique identifier for the desired destination, or use the arrow keys to select a desired class from the options presented by auto complete, and the tab key to enter the selection in the character entry area 1102. Next, the developer can type a double colon or other operator, which may operate to display the members of the identified class 1103. The developer can once again either type enough characters to make the string a unique identifier for the desired destination, or use the arrow keys to select a desired constructor from the options presented by auto complete, and the tab key to enter the selection in the character entry area 1104. Finally, the developer can strike the “enter” key or execute the search by other means 1004. In response to executing the search, the identified symbol may be located and presented.

Consider an example of the above process illustrated in FIG. 11. A developer wants to go to the definition of the constructor of the “CMangler” class: The developer The developer can open the search element 1000, and type “CMan” 1101 in the character entry area this would highlight the “CMangler” class in the completion list. The developer can depress <tab> to complete the class identification 1102 and then type “::” (for C++) or “.” (for C# and VB) 1103. The developer may then be presented with another completion list including the members of the “CMangler” class. The developer can type a few letters or use the arrow keys to select the desired constructor 1104, then hit <Enter> 1105. In response, the location of the desired symbol in source code is displayed.

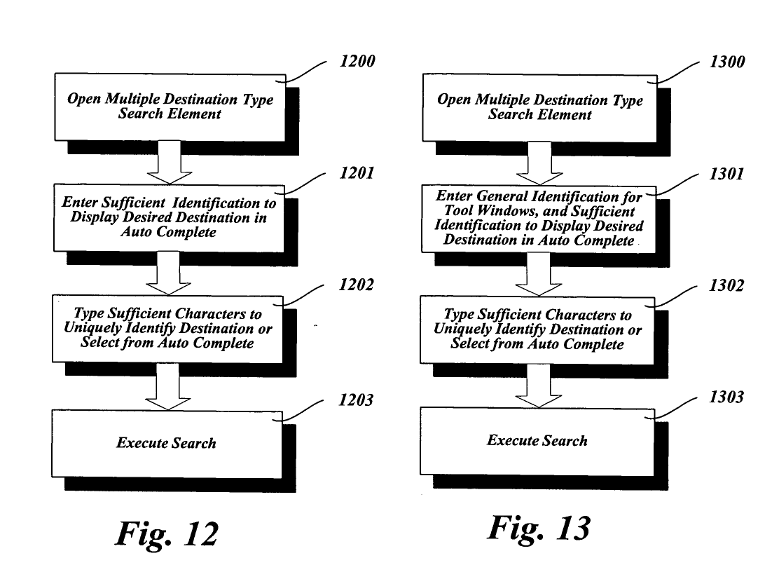

Referring to FIG. 12, exemplary steps are provided for using the search element to navigate to a file, code line, symbol, or bookmark. First, a developer may open a search element capable of navigating to a variety of destinations 1200. Next, the developer may type in sufficient identification information to bring up a set of completion options that includes the desired destination 1201. At this point, the developer can either type enough characters to make the string a unique identifier for the desired destination, or use the arrow keys to select a desired bookmark from the options presented by auto complete, and the tab key to enter the selection in the character entry area 1202. Finally, the developer can strike the “enter” key or execute the,search by other means 1203. In response to executing the search, the line marked with the identified destination, e.g. a bookmark may be located and presented, which may include opening a corresponding file.

Consider an example of the above process illustrated in FIG. 12. To navigate to a bookmark named “Compiler Bug,” the developer may open the search element 1200, and type “compi” 1201 which brings up a completion list including the “Compiler Bug” bookmark. The developer can either type a few more characters to make the list contain a unique hit or they could use the arrow keys to select the desired bookmark, and tab key to place the selection in the character entry area 1202. The developer may then select a selectable element for executing the search 1203. In response, the location containing the desired bookmark is displayed.

Referring to FIG. 13, exemplary steps are provided for using the search element to navigate to a tool window. The typical scenario is that of navigating to a tool window from the context of an editor window or another tool window. In traditional IDE GUIs, this has been complicated because it involved knowing the different shortcut keys for each tool window used, typically more than ten shortcut key combinations may be memorized for various tool windows. Some tool windows use function keys, for example, the property grid tool window can be accessed in VISUAL STUDIO® using the F4 key, while other tool windows use ctrl-shift-key combinations. For example, class view and solution explorer windows in VISUAL STUDIO® use ctrl-shift-key combinations. Having one shortcut key that allows navigation to any window is a time saving feature for developers.

First, a developer may open a search element capable of navigating to a variety of destinations 1300. Next, the developer can type a first character or set of characters that indicate he or she intends to navigate to a tool window, followed by characters that identify the particular desired tool window 1301. At this point, the developer can either type enough characters to make the string a unique identifier for the desired destination, or use the arrow keys to select a desired tool window from the,options presented by auto complete, and the tab key to enter the selection in the character entry area 1302. Finally, the developer can strike the “enter” key or execute the search by other means 1303. In response to executing the search, the identified tool window may be may be located and presented in the GUI, either in a floating window, in the workspace, or by some other means.

Consider an example of the above process illustrated in FIG. 13. To go to the object browser, a developer may open the search element 1300, and type “w:Obj” 1301, which may bring up a completion list including the “Object Browser” tool window. The developer can either type a few more characters to make the list contain a unique hit or they could use the arrow keys to select the desired tool window, and tab key to place the selection in the character entry area 1302. The developer may then select a selectable element for executing the search, or depress “Enter,” to execute the search 1303. In response, the desired tool window, object browser, can be displayed. To go back to the editor window, a developer can again open the search element 1300 and type “w:Ed” 1301, hit <tab> to select “Editor” 1302 and press <Enter> 1303.

Embodiments of the invention may also allow navigation forward or backward to previous or subsequent tool windows by entering certain character combinations in the character recognition area. For example, to go back to the previous window, the developer might again open the search element 1300 and type “w:” and then execute the search, knowing that it will lead to a previous tool window.

Furthermore, embodiments of the invention could be extended to map any window mnemonic to a tool window. In other words, a developer could map his or her own keys to certain tool windows. By entering the specified characters in the character recognition area, and executing the search, the desired tool window can be opened. For example, a developer could map “cv” to “w:Class View” or map “myw” to a window that they just created using an add-in they wrote.

Exemplary Computing and Network Environment

With reference to FIG. 2a, an exemplary computing device 200 suitable for use in connection with the systems and methods of the invention is broadly described. In its most basic configuration, device 200 typically includes a processing unit 202 and memory 203. Depending on the exact configuration and type of computing device, memory 203 may be volatile (such as RAM), non-volatile (such as ROM, flash memory, etc.) or some combination of the two. Additionally, device 200 may also have mass storage (removable 204 and/or non-removable 205) such as magnetic or optical disks or tape. Similarly, device 200 may also have input devices 207 such as a keyboard and mouse, and/or output devices 206 such as a display that presents a GUI as a graphical aid accessing the functions of the computing device 200. Other aspects of device 200 may include communication connections 208 to other devices, computers, networks, servers, etc. using either wired or wireless media. All these devices are well known in the art and need not be discussed at length here.

FIG. 2b illustrates a somewhat more detailed example of a suitable computing device from FIG. 2a and peripheral systems. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be implemented in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2b, an exemplary system for implementing the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 2b, provide storage of computer readable instructions, data structures, program modules and other data for the computer 241. In FIG. 2b, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2b. The logical connections depicted in FIG. 2b include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2b illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing the present invention in the context of one or more stand-alone computer systems, the invention is not so limited, but rather may be implemented in connection with any computing environment, such as a network or distributed computing environment. Still further, the present invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

An exemplary networked computing environment is provided in FIG. 2c. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2c provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2c, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2c, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, Hyper Text Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework of provided in FIG. 2a and FIG. 2b, and the further diversification that can occur in computing in a network environment such as that of FIG. 2c, the systems and methods provided herein cannot be construed as limited in any way to a particular computing architecture. Instead, the present invention should not be limited to any single embodiment, but rather should be construed in breadth and scope in accordance with the appended claims.

What is claimed:

1. A method for causing an item to be displayed from a Graphical User Interface of an Integrated Development Environment (IDE) comprising:
presenting a search element for finding items of a plurality of types, wherein said types are selected from a group comprising a file type and a line of code type;
receiving at least one character through an entry area in said search element;
determining a type for said at least one character;
displaying a line of code in a Graphical User Interface (GUI) for an Integrated Development Environment (IDE) if said at least one character is of the line of code type.

2. The method of claim 1, wherein said line of code is identified by the at least one character.

3. The method of claim 1, further comprising displaying a file in the GUI if said at least one character is of the file type.

4. The method of claim 3, wherein displaying a file comprises opening the file and placing its contents in a workspace of said GUI.

5. The method of claim 1, further comprising receiving at least one second character that identifies a line of code within a file.

6. The method of claim 5, further comprising displaying a portion of the file identified by at least one second character if said at least one character is of the file type.

7. The method of claim 1, further comprising a bookmark type in said group, and further comprising displaying a location identified by a bookmark in the GUI if said at least one character is of the bookmark type.

8. The method of claim 1, further comprising a symbol type in said group, and further comprising displaying a location identified by a symbol in the GUI if said at least one character is of the symbol type.

9. The method of claim 1, further comprising a tool window type in said group, and further comprising displaying a tool window in the GUI if said at least one character is of the tool window type.

10. The method of claim 9, further comprising reserving at least one character sequence to indicate a tool window type.

11. The method of claim 10, further comprising displaying an identification of at least one item identified by said at least one character, wherein said displaying is substantially proximal to said entry area.

12. A computer readable medium bearing instructions for causing an item to be displayed from a Graphical User Interface of an Integrated Development Environment (IDE) comprising:
instructions for presenting a search element for finding items of a plurality of types, wherein said types are selected from a group comprising a file type and a line of code type;
instructions for receiving at least one character through an entry area in said search element;
instructions for determining a type for said at least one character;
instructions for displaying a line of code in a Graphical User Interface (GUI) for an Integrated Development Environment (IDE) if said at least one character is of the line of code type.

13. The computer readable medium of claim 12, wherein said line of code is identified by the at least one character.

14. The computer readable medium of claim 12, further comprising instructions for displaying a file in the GUI if said at least one character is of the file type.

15. The computer readable medium of claim 14, wherein the instructions for displaying a file comprise instructions for opening the file and instructions for placing its contents in a workspace of said GUI.

16. The computer readable medium of claim 15, further comprising instructions for receiving at least one second character that identifies a line of code within a file.

17. The computer readable medium of claim 16, further comprising instructions for displaying a portion of the file identified by at least one second character if said at least one character is of the file type.

18. The computer readable medium of claim 12, further comprising a bookmark type in said group, and further comprising instructions for displaying a location identified by a bookmark in the GUI if said at least one character is of the bookmark type.

19. The computer readable medium of claim 12, further comprising a symbol type in said group, and further comprising instructions for displaying a location identified by a symbol in the GUI if said at least one character is of the symbol type.

20. The computer readable medium of claim 12, further comprising a tool window type in said group, and further comprising instructions for displaying a tool window in the GUI if said at least one character is of the tool window type.

21. The computer readable medium of claim 20, further comprising instructions for reserving at least one character sequence to indicate a tool window type.

22. The computer readable medium of claim 21, further comprising instructions for displaying an identification of at least one item identified by said at least one character, wherein said instructions for displaying place the identification substantially proximal to said entry area.

23. In a computer system with a display surface, a Graphical User Interface (GUI) for display on the display surface comprising:
at least one single search element comprising a character entry area, wherein a search can be executed for items identified by characters in said character entry area; and wherein:
if a user enters characters identifying a file in said character entry area, then when a search is executed, the file is displayed in the GUI; and
if the user enters characters identifying a line of code in said character entry area, then when a search is executed, the line of code is displayed in the GUI.

24. The computer system of claim 23, wherein the single search element is displayable by selecting one or more selectable elements in the GUI.

25. The computer system of claim 23, wherein the single search element is displayable by depressing one or more shortcut keys on a keyboard coupled to said computer system.

26. The computer system of claim 23, further comprising at least one selectable sequence of characters that is displayed when characters are entered in said character entry area.

27. The computer system of claim 26, wherein if more than one selectable sequence of characters is displayed when characters are entered in said character entry area, then a selection among the multiple selectable sequences of characters can be made by depressing a key on the keyboard.

28. The computer system of claim 23, wherein if the user enters only an integer in said character entry area, then when a search is executed, a line of code from an open file is displayed in the GUI.

29. The computer system of claim 23, wherein if a user enters characters identifying both a file and a line of code in said character entry area, then when a search is executed, the portion of the identified file with the identified line of code is displayed in the GUI.

30. The computer system of claim 23, wherein if the user enters characters identifying a symbol in said character entry area, then when a search is executed, the symbol is displayed in the GUI.

31. The computer system of claim 23, wherein if the user enters characters identifying a bookmark in said character entry area, then when a search is executed, the location in an item identified by the bookmark is displayed in the GUI.

32. The computer system of claim 23, wherein if the user enters characters identifying a tool window in said character entry area, then when a search is executed, the tool window is displayed in the GUI.
